(19) United States
(12) Patent Application Publication
(10) Pub. No.: US 2017/0071246 A1
(43) Pub. Date: Mar. 16, 2017

(54) LOW-TEMPERATURE, FORCED-CONVECTION, STEAM-HEATING OF NUTS

(71) Applicant: LAITRAM, L.L.C., Harahan, LA (US)

(72) Inventors: Brent A. LEDET, River Ridge, LA (US); Garrett B. FINE, New Orleans, LA (US); James M. LAPEYRE, III, New Orleans, LA (US)

(21) Appl. No.: 15/122,824

(22) PCT Filed: Mar. 3, 2014
(86) PCT No.: PCT/US2014/019789

§ 371 Date: Aug. 31, 2016

(51) Int. Cl. A23N 12/08; A23L 25/00; A23B 7/005

(52) U.S. Cl. CPC A23N 12/08; A23B 7/0053; A23L 25/20; A23V 2002/00

(57) ABSTRACT

Apparatus and methods for heat-treating almonds and other nuts and food products with steam at atmospheric pressure. The amount of condensation on and the consequent water uptake of almonds is limited by heating the almonds in a low-temperature gaseous atmosphere including a steam mixture and forming a forced-convection path through the almonds. The limited water uptake prevents the almond skins from blistering. A forced-convection steam cooker conveying food products on a foraminous conveyor belt the cooker forces the steam mixture downward through the food product along a portion of the cooker and upward along another portion of the cooker for a more uniform heat treatment.

### BACKGROUND

The invention relates generally to steam cooking and more particularly to apparatus and methods for steam-heating nuts with forced convection at low temperatures.

Nuts, such as almonds, are often pasteurized by immersion in hot water or an air-steam environment. Steam pasteurizers conventionally use the heat of condensation to heat the outer surfaces of nuts to temperatures high enough to deactivate enough micro-organisms to meet acceptable pasteurization levels. The nuts enter the steam pasteurizer at a temperature below the temperature of the steam. The steam condenses on the outer surface of the nuts and raises their temperature. But the condensation can wrinkle and loosen the outer skins of the nuts. In the case of almonds and other nuts to be sold in their skins, the nuts' uptake of water should be limited. One approach to limiting condensation in almonds is described in International Patent Publication No. WO 2013/171336. That document teaches pre-heating low-moisture foods to a temperature above or slightly below the condensation temperature of the water vapor in the heating chamber to limit condensation. Another approach, described in U.S. Patent Application Publication No. 2013/0040030, steams nuts at a pressure below atmospheric to limit water uptake. But pre-heating requires an additional heater, and a vacuum system requires batch and not continuous handling.

### SUMMARY

One method embodying features of the invention for heat-treating almonds comprises: (a) conveying almonds through a heating chamber on a foraminous conveyor belt; (b) forcing a substantially homogeneous gaseous atmosphere comprising a steam mixture along a convection path through the foraminous conveyor belt and the almonds in the heating chamber to heat the outer skins of the almonds and limit the amount of water condensation on the skins to prevent the wrinkling of the skins; (c) maintaining atmospheric pressure in the heating chamber; (d) controlling the temperature of the gaseous atmosphere in the heating chamber to a heating temperature of less than 85° C.; and (e) controlling the dwell time of the almonds in the heating chamber as a function of one or more of the heating temperature, the length of the heating chamber, the speed of the conveyor belt, and the thickness of the mat of almonds on the conveyor belt.

In another aspect of the invention, a method for heat-treating nuts comprises: (a) conveying nuts along a conveying path through a heating chamber on a foraminous conveyor belt; (b) forcing a substantially homogeneous gaseous atmosphere comprising a steam mixture along a convection path through the foraminous conveyor belt and the nuts in the heating chamber to heat the outer skins of the nuts and limit the amount of water condensation enrobing the skins, wherein the convection path is perpendicular to the conveying path; (c) maintaining atmospheric pressure in the heating chamber; (d) controlling the temperature of the gaseous atmosphere in the heating chamber to a heating temperature of less than 85° C.; and (e) controlling the dwell time of the nuts in the heating chamber as a function of one or more of the heating temperature, the length of the heating chamber, the speed of the conveyor belt, and the size and kind of nut, and the thickness of the mat of nuts on the conveyor belt.

In another aspect of the invention, a steam cooker embodying features of the invention comprises a first heating region open to the atmosphere and having a first steam outlet injecting steam into the first heating region and a second cooking region open to the atmosphere and in series with the first cooking region and having a second steam outlet injecting steam into the second heating region. A foraminous conveyor conveys a food product through the steam cooker along a conveying path. A first air circulator circulates air mixed with the injected steam along a first convection path intersecting the food product being conveyed through the first heating region. The first convection path is directed in a first direction through the foraminous conveyor. A second air circulator circulates air mixed with the injected steam along a second convection path intersecting the food product being conveyed through the first heating region on the foraminous conveyor. The second convection path is directed in a second direction opposite the first direction through the foraminous conveyor. Means for maintaining the temperature in the first and second cooking regions maintains the temperature below 100° C.

### BRIEF DESCRIPTION OF THE DRAWINGS

These features and aspects of the invention, as well as its advantages, are described in more detail in the following description, appended claims, and accompanying drawings, in which:

FIG. 1 is a side view of a portion of a steam cooker, with its facing sidewall removed for clarity, embodying features of the invention; and

FIG. 2 is an axial cross sectional view of the steam cooker of FIG. 1; and

FIG. 3 is a side-elevation cross sectional view of the steam cooker of FIG. 1.

### DETAILED DESCRIPTION

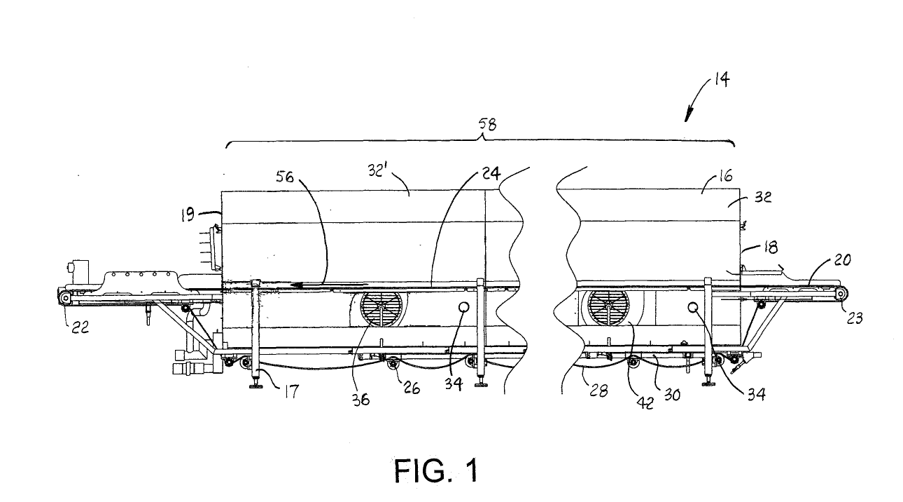

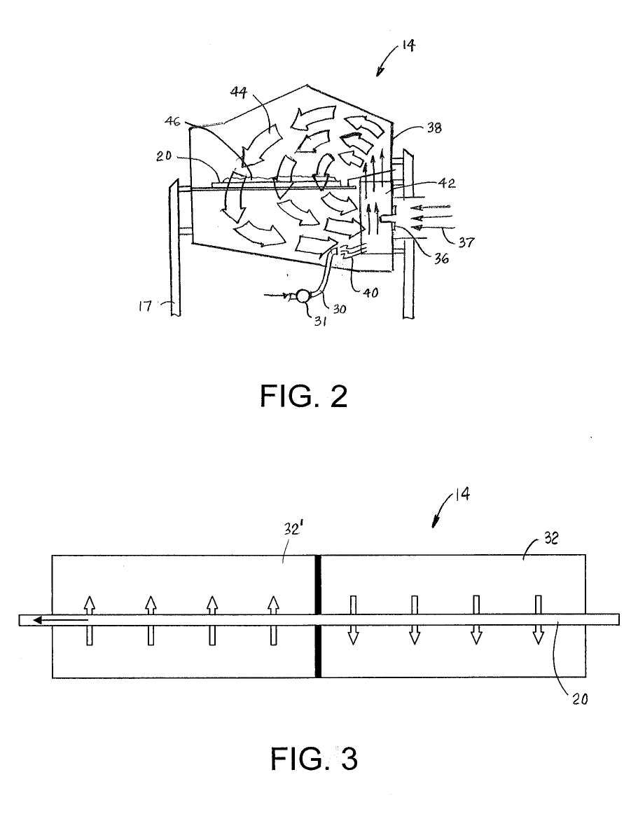

A steam cooker that operates according to and embodies features of the invention is shown in FIG. 1 with its facing side wall removed to better illustrate its components. The cooker 14 has an enclosure 16, open to the atmosphere, that is supported on legs 17 and extends from an entrance end 18 to an exit end 19. A foraminous conveyor belt 20 is trained around drive and idle sprockets 22, 23 at opposite ends of an upper carryway 24 that traverses the cooker. Diverting rollers or drums 26 guide the endless belt loop along a returnway 28 below the cooker. A network of steam pipes 30 injects steam supplied by a boiler or other steam source into the cooker through the bottom of the enclosure. The injection of steam is regulated by valves 31 (in FIG. 2) in the steam network.

The cooker shown is modular with at least two identical heating modules 32, 32′. More modules may be connected in series to lengthen the total low-temperature heating region. A single module could be used for food products that require only a brief heating time. Each module is individually controlled with its own steam valves. A feedback signal from a temperature-sensing probe 34 in each heating module is used by a controller, such as a programmable logic controller, to control the opening of the steam-injector valve to maintain a predetermined heating temperature in each module. The probe, the controller, and the valve provide a means for maintaining a pre-selected temperature in each module. Air circulators, such as fans 36 or blowers, draw air 37 into the cooker through one of the side walls 38, as also shown in FIG. 2. The fan also draws steam 40 injected into the cooker through openings in a plenum 42, in which the air and steam are mixed. The fan blows the air-steam mixture through openings in the top of the plenum. The air-steam mixture then circulates along a convection path, indicated by arrows 44, that intersects nuts 46 being conveyed atop the conveyor belt 20 along the carryway. The belt is foraminous to allow the air-steam mixture to pass through and also to allow any condensation to drain. Other features of such a forced-convection cooker as described thus far are given in U.S. Pat. No. 6,274,188, “Method for Steam-Cooking Shrimp at Reduced Temperatures to Decrease Yield Loss,” Aug. 14, 2001, incorporated herein by reference. One example of such a cooker is the CoolSteam® cooker manufactured and sold by Laitram Machinery, Inc., of Harahan, La., U.S.A. Because of the thoroughness of the forced-convection heat treatment described, heat-treating at temperatures of less than 100° C. at atmospheric pressure is possible. In fact, temperatures in the heating region below 85° C. and preferably in the range from 62° C. to 79° C. are effective in blanching or pasteurizing almonds without blistering or loosening their skins because the low temperatures minimize the uptake of moisture by the almonds.

In operation, nuts, such as peanuts or almonds and other tree nuts, are conveyed into the steam cooker 14 by the conveyor belt 20 along a conveying path 56. The nuts are heated in a low-temperature cooking region 58 that may include one or more identical forced-convection heating modules 32, 32′. Air is drawn into the modules and mixed with steam to form a substantially homogeneous gaseous atmosphere of air (or other gas, such as nitrogen) and steam or water vapor. This steam mixture is circulated by an air circulator, such as a fan, in a convection path that intersects the food product. Along with the low-temperature heat treatment, the forced-convection flow through the nuts shears condensation enrobing the nuts and inhibits the uptake of moisture. The duration of the heating—the dwell time—is set by one or more of: (a) the length of the low-temperature heating region 58, (b) the speed of the conveyor belt 20, (c) the temperature of the heating region, (d) the size and kind of nut, and (e) the thickness of the mat of nuts on the conveyor belt. For almonds, the dwell time may range from 4 to 9 minutes in order to achieve sufficient lethality, e.g., a 6 log reduction in a target organism, such as salmonella. The temperature of the heating region is measured by a temperature probe and controlled by the amount of steam introduced into the cooker in each module.

. 3 shows the steam cooker 14 with two heating modules 32, 32′. In the first module 32, the convection path through the foraminous conveyor belt 20 and the conveyed nuts 46 is downward. In the second module 32′, the convection path is upward through the nuts. Subjecting the nuts or other food products to both upward and downward convection flows results in a more uniform heat treatment.

1. A method for heat-treating almonds, comprising:
conveying almonds through a heating chamber on a foraminous conveyor belt;
forcing a substantially homogeneous gaseous atmosphere comprising a steam mixture along a convection path through the foraminous conveyor belt and the almonds in the heating chamber to heat the outer skins of the almonds and limit the amount of water condensation on the skins to prevent the wrinkling of the skins;
maintaining atmospheric pressure in the heating chamber;
controlling the temperature of the gaseous atmosphere in the heating chamber to a heating temperature of less than 85° C.;
controlling the dwell time of the almonds in the heating chamber as a function of one or more of the heating temperature, the length of the heating chamber, the speed of the conveyor belt, and the thickness of the mat of almonds on the conveyor belt.

2. The method of claim 1 wherein the heating temperature ranges from 62° C. to 79° C.

3. The method of claim 1 wherein the dwell time is between 4 and 9 minutes.

4. The method of claim 1 wherein the convection path is upward in a first portion of the heating chamber and downward in a second portion.

5. A method for heat-treating nuts, comprising:
conveying nuts along a conveying path through a heating chamber on a foraminous conveyor belt;
forcing a substantially homogeneous gaseous atmosphere comprising a steam mixture along a convection path through the foraminous conveyor belt and the nuts in the heating chamber to heat the outer skins of the nuts and limit the amount of water condensation enrobing the skins, wherein the convection path is perpendicular to the conveying path;
maintaining atmospheric pressure in the heating chamber;
controlling the temperature of the gaseous atmosphere in the heating chamber to a heating temperature of less than 85° C.;
controlling the dwell time of the nuts in the heating chamber as a function of one or more of the heating temperature, the length of the heating chamber, the speed of the conveyor belt, and the size and kind of nut, and the thickness of the mat of nuts on the conveyor belt.

6. The method of claim 5 wherein the convection path is upward in a first portion of the heating chamber and downward in a second portion.

7. A steam cooker comprising:
a first heating region open to the atmosphere and having a first steam outlet injecting steam into the first heating region;
a foraminous conveyor conveying a food product through the steam cooker along a conveying path;
a first air circulator circulating air mixed with the injected steam along a first convection path intersecting the food product being conveyed through the first heating region on the foraminous conveyor, wherein the first convection path is directed in a first direction through the foraminous conveyor;
a second cooking region open to the atmosphere and in series with the first cooking region and having a second steam outlet injecting steam into the second heating region;
a second air circulator circulating air mixed with the injected steam along a convection path intersecting the food product being conveyed through the first heating region on the foraminous conveyor, wherein the second convection path is directed in a second direction opposite the first direction through the foraminous conveyor;
means for maintaining the temperature in the first and second cooking regions at a temperature below 100° C.

8. A steam cooker as in claim 6 wherein the first direction is downward and the second direction is upward.
